(19) United States
(12) Patent Application Publication
(10) Pub. No.: US 2014/0188665 A1
(43) Pub. Date: Jul. 3, 2014

(54) CrowdChunk System, Method, and Computer Program Product for Searching Summaries of Online Reviews of Products

(71) Applicants: Douglas Dane Baker, Cary, NC (US); Brian Fernandes, San Diego, CA (US); Paulo Malvar Fernandez, La Mesa, CA (US)

(72) Inventors: Douglas Dane Baker, Cary, NC (US); Brian Fernandes, San Diego, CA (US); Paulo Malvar Fernandez, La Mesa, CA (US)

(73) Assignee: CrowdChunk LLC, Cary, NC (US)

(21) Appl. No.: 14/058,263

(22) Filed: Oct. 20, 2013

Related U.S. Application Data
(63) Continuation-in-part of application No. 13/732,880, filed on Jan. 2, 2013.

(51) Int. Cl. G06Q 30/06

(52) U.S. Cl. CPC G06Q 30/0625
USPC 705/26.62

(57) ABSTRACT

System, method, and computer program product for researching reviews written online to assess the performance and functionality of digital media consumer products bought online or not (e.g. eBooks, movies, TV shows, music, DVD's, etc.). The system extracts reviews from multiple online sources comprising: online “stores”, professional articles, blogs, online magazines, websites, etc.; and, utilizes sentiment analysis algorithms and supervised machine learning analysis to present more informative summaries for each product's reviews, comprising: a sentence that encapsulates a sentiment held by many users; the most positive and negative comments; and a list of features with average scores (e.g. performance, price, etc.). Additionally, the user may view a separate review detail page per product that provides further summaries, such as a short list of other products that the same reviewer gave a very positive review for the features. The user is then able to purchase the product via a link.

### PRIORITY CLAIM

The present application is a continuation-in-part of and claims priority to U.S. Utility patent application Ser. No. 13/732,880 filed Jan. 2, 2013 by Baker et al entitled “CrowdChunk System, Method, and Computer Program Product for Searching Summaries of Mobile Apps Reviews”, the teachings of which are incorporated herein by reference in their entirety.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to a web-based interface to assist users in selecting products based upon a computer implemented analysis of multiple reviews of the products.

### BACKGROUND OF THE INVENTION

The online tools currently provided to display and view the millions of reviews of retail products, comprising consumer goods and services is limited. Generally a user can only retrieve a listing of user reviews and at best sort them by a rating that the user gives to a product in addition to the review text submitted. There has been very little done with regard to analyzing the review text directly for relevant details to provide to the end user evaluating a product's reviews to determine if s/he wants to purchase the product.

For example, United States Patent Application 20130066800 entitled “METHOD OF AGGREGATING CONSUMER REVIEWS” by Falcone et al, discloses a computer-based review website, system, and method that automatically aggregates relevant reviews onto an individual, first computer-based review website to enhance searches performed by consumers and enhance the SEO for companies that depend on such consumer searches. But, the system provides no analysis of the reviews to generate metrics as a means to objectively compare and contrast similar products. The system also relies only on consumer reviews and not industry expert reviews, which provide a more reliable evaluation of a product's advantages and disadvantages to the consumer.

Similarly, United States Patent Application 20120185455, entitled “SYSTEM AND METHOD OF PROVIDING SEARCH QUERY RESULTS”, by Hedrevich discloses a system and method for searching and ranking information based on consumer product reviews with a search engine that allows the user to search a database by using terms that describe a product based on other users' comments. Search results may include the product review information, the product name, the product picture, the product price, and users reviewed excerpts. And while an algorithm is disclosed for computing the relevance ranking using Levenshtein distance, Okapi BM25 factor, and Phrase proximity ranking algorithms, no analysis is conducted to compare and contrast competitive products.

And while United States Patent Application 20130066873 A1, entitled “AUTOMATIC GENERATION OF DIGITAL COMPOSITE PRODUCT REVIEWS” discloses an automated computer system for computing the representativeness, coherence, liveliness, and informativity of a composite review. A composite review (compilation of multiple user reviews) is deemed “lively” the review contains at least one superlative word; the phrase contains at least one comparative word; the phrase contains at least one degree modifier word; etc.; and, likewise for computing the representativeness, coherence, and informativity. But again, the automated system does not compare and contrast via objective statistical analysis different products from the same class.

These inventions do not disclose comparing and contrasting different retail products using statistical analysis or other computing methods to highlight the most positive and most negative features of the product as determined by multiple reviewers, and to quantify the ratings of the particular features; as well as to provide separate displays of reviews by professional industry reviewers versus non-technical user reviewers.

Neither do these systems provide a cross-referencing feature to display another product: 1) that a reviewer rated as highly as the product that the user is investigating in order for them to comparison shop; nor 2) that a reviewer who gave a negative rating to the user's product of interest, alternatively rated other products as highly in order for the user to find a better product.

### SUMMARY OF THE INVENTION

The present invention provides the CrowdChunk system, method and computer program product (e.g. mobile App) and/or web-based service (e.g. webpage) to enable users to search for and select products comprising consumer goods and/or services sold online and via other venues, but for which reviews of the product are viewable on the Internet. In one embodiment, the products comprise digital media purchased for online streaming, downloading, accessing via the Internet, and/or physically shipping to the user, who is able to search for a particular product by name or product identification number, and/or search an entire class of products. The reviews are pulled from various online sources comprising: new stories, blogs, online magazines, retailer websites, and online reviews by professionals, etc. The system utilizes opinion/sentiment analysis algorithms and supervised machine learning to present more informative summaries for each product's reviews comprising data analysis and metrics of rated features of a product, such as the ease-of-use. The user may then click a link to purchase the product from the original source (e.g. online retailer). In an additional embodiment, the user may purchase the product from the CrowdChunk webpage.

In a preferred embodiment, the user may view one or more of the following “Summaries” from the system analysis for a particular product the user is interested in purchasing:
1) A section containing one or more summary sentences from a reviewer that encapsulates a sentiment held by many reviewers, and displays that sentence in quotes and states, for example, “[x] of users out of [y] made a similar statement”.
2) The most positive and/or negative reviews comprising a list of 2 or more pulled quotes culled from the reviews that the CrowdChunk system CPU determines are the most positive and/or negative reviews.
3) A list of features extracted from the reviews with the average score as calculated by the system CPU next to them (e.g. Graphics 80%, Easy to Use 10%, Fun factor 40%).
4) A separate Review Detail Page for the product of interest (shown when the user clicks on a link within (1), (2), or (3) above), comprising a “Positive” or “Negative” score for each feature extracted. The Review Detail Page may also comprise an “Product Review Cross-Referencing Feature” providing a list of other products that a reviewer who: 1) gave a high rating to the user's searched product, also gave a high rating to the products on the list; and 2) gave a low rating to the user's searched product, but gave a high rating to similar products on the list.
5) A Professional Reviews Page comprising a listing of reviews extracted from online sources published by professionals who evaluate the performance of the product. Sources of the professional reviews may comprise, for example, professional blogs, online magazines, websites, etc.

The opinion/sentiment analysis algorithms and machine learning methods comprise primarily three main computer processes/subsystems/modules: 1) Review extraction and storage (aka “Review Scraper”); 2) Sentiment Analysis and Feature Extraction (SAFE); and 3) Query Interface Web Application. During Review extraction and storage, the system makes HTTP requests to a product information website (e.g. an online retailer, consumer reports, etc.) to retrieve all user submitted reviews for every type of product. These reviews are stored in a relational database after preprocessing, in a format that can be used as input to the Sentiment Analysis and Feature Extraction (SAFE) subsystem. The Review Scraper subsystem can also be configured to retrieve data from other online sources of reviews and/or information (e.g. product liability lawsuits). The Review Scraper subsystem will also periodically retrieve review data from the above mentioned data sources to keep the system's database of Review data up-to-date. The frequency of updating the review data is configurable, and may comprise, for example, daily to once per week system updating.

Sentiment Analysis and Feature Extraction (SAFE) retrieves the prepossessed reviews from the Review database and subsequently performs lexical analysis and supervised machine learning analysis to create summaries of the reviews comprising statistical analysis and metrics calculated by the CrowdChunk CPU for various features of a particular product that the user is researching. As disclosed in a preferred embodiment supra, the Summaries may comprise, for example: a sentence that encapsulates a sentiment held by many users; the most positive and negative comments; and a list of extracted features with average scores (e.g. graphics, fun, easy to use, etc.). Additionally, the Summaries may comprise cross-referencing details to other products, such as a short list of other products (with its commercial name and icon) that: 1) a reviewer who gave a positive rating to the user's product of interest, also rated highly in order to comparison shop; and 2) a reviewer who gave a negative rating to the user's product of interest, alternative rated other products highly in order to find a better performing product. These SAFE derived Summaries are subsequently stored in the system's Review Analytics Database.

In one embodiment, the SAFE process comprises a Statement Matching algorithm that: 1) finds one or more Canonical Statements within a Product's review dataset that contain comments, observations, or sentiments statistically likely to be shared by multiple reviews in the dataset; and, 2) determines the subset of reviews that made statistically similar statements to these Canonical Statements.

The user then uses the Query Interface Web Application to search for the SAFE Summaries in the Review Analytics Database. This may comprise a computer program product of the present invention such as a mobile App, or a web-based service (e.g. website) to conduct the search and view the retrieved summaries. The user is also able to use the Query Interface Web Application to click on a link to purchase the product from its original source (e.g. online retailer).

### BRIEF DESCRIPTION OF THE DRAWINGS

The above and other features, aspects, and advantages of the present invention will become better understood with regard to the following description, appended claims, and accompanying drawings where:

FIG. 1 is a Unified Modeling Language (UML) sequence diagram for the steps of the user inputting a search for a particular type of product, and the system server responding to the request with analyzed metrics for relevant products.

FIG. 2A is an illustration of the system architecture comprising the CrowdChunk system server in communication with the product data sources and the client computing devices via the Internet.

FIG. 2B is an illustration of data flow for one particular exemplification of FIG. 2A for pulling reviews from an product retailer's website, processing them by the CrowdChunk system server, and then searching for and viewing analyzed summaries of the reviews on a user's electronic computing device.

FIG. 3A is a flowchart of computer processor steps for the Review Scraper module.

FIG. 3B is a Unified Modeling Language (UML) sequence diagram for the steps followed by the Review Scraper module.

FIG. 4A is a flowchart of computer steps for the Sentiment Analysis Feature Extraction (SAFE) Module.

FIG. 4B is a Unified Modeling Language (UML) sequence diagram for the steps flowed by the Sentiment Analysis Feature Extraction (SAFE) Module.

FIG. 5 is a detailed flowchart of computer processor steps followed during the Lexical Analysis step of the SAFE module.

FIG. 6 is a detailed flowchart of computer processor steps followed during the Supervised Machine Learning Analysis step of the SAFE module.

FIG. 7 is a detailed flowchart of the computer processor steps followed during the Machine Learning Topic Detection.

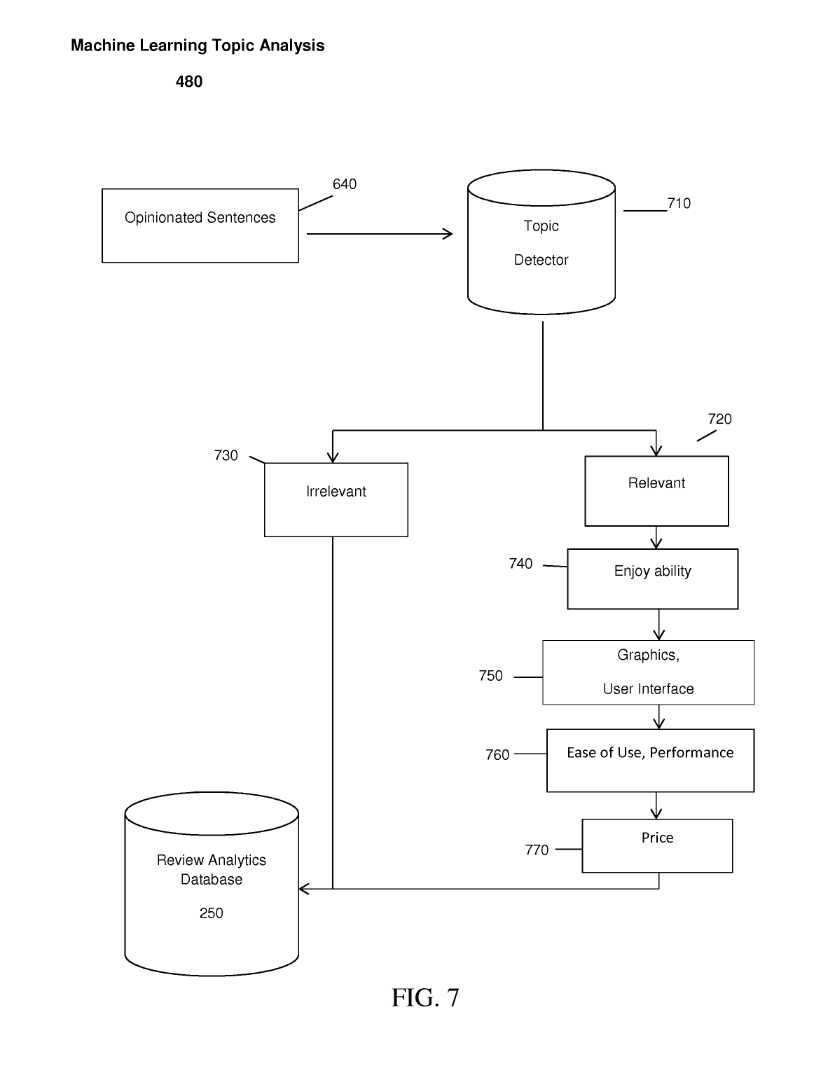

FIG. 8A is a flowchart of the computer processor steps followed during the Statement Matcher Analysis for finding canonical statements.

FIG. 8B is a flowchart of the computer processor steps followed during the Statement Matcher Analysis for finding similar statements.

### DETAILED DESCRIPTION

### Glossary of Terms

As used herein, the term “Product” refers to any service and/or consumer good for which reviews evaluating the product are available on the Internet. Products may comprise, for example, digital media purchased for online streaming, downloading, accessing via the Internet, and/or physically shipping to the user. Examples of digital media applicable to the present invention comprise: eBooks; paper books bought online and shipped; podcasts; digital movies, music, video games, audio books, TV shows, and desktop computer applications, that are streamed online or downloaded; and, DVD's copies purchased online and shipped to the user (e.g. DVD's).

As used herein, the term “Client Electronic Computing Device” refers to any user electronic device comprising a central processing unit (i.e. processor) with the ability to transmit and receive electronic communications comprising via Internet and/or cellular connectivity, such as: laptops, desktops, tablets, iPads, iPods, smartphones, cell phones, and personal digital assistant devices. In a preferred embodiment, the user's device is an iOS Internet-enabled device to permit the user to purchase and download the product identified in the search of the system database. It is noted, though, that any Internet-enabled mobile or non-mobile device of any type of operating system may search for products on the system database via the website of the present invention.

As used herein, the term “A System” may be used to claim all aspects of the present invention wherein it refers to the entire configuration of hardware and software in all embodiments. In a preferred embodiment, the “system” comprises a user computing device with Internet connectivity (e.g. laptops, tablets, smartphones, etc.). In an alternative embodiment of the present invention, the system comprises a client-server architecture comprising a user computing device with Internet connectivity, such as laptops, tablets, and smartphones, to communicate with a system server via a network, wherein the software of the present invention is installed on the system server and electronically communicates with the user's device over the Internet. Furthermore, the user's computing device may have modules of the present invention installed to assist in the user.

As used herein the term “Server” computer refers to any computing device that collects and stores the products' records on a database and executes the software programs of the present invention to search the database for a product with user desired features. The server system also facilitates the collection and distribution of content (e.g. product reviews) to and from a multiplicity of computers and servers.

As used herein, the term “Software” refers to computer program instructions adapted for execution by a hardware element, such as a processor, wherein the instruction comprise commands that when executed cause the processor to perform a corresponding set of commands. The software may be written or coded using a programming language, and stored using any type of non-transitory computer-readable media or machine-readable media well known in the art. Examples of software in the present invention comprise any software components, programs, applications, computer programs, application programs, system programs, machine programs, and operating system software.

As used herein, the term “Module” or “Subsystem” refers to a portion of a computer program or software that carries out a specific function (e.g. Review Scraper module, SAFE module, etc.) and may be used alone or combined with other algorithms/modules of the same program. The programs may be stored on non-transitory computer-readable media to enable computers and/or computer systems to carry our part or all of the methods encoded therein.

As used herein, the term “App” or “app” refers to application software downloaded to a mobile device via the Internet. The computer software is designed to help the user perform specific tasks on or from their mobile device.

As used herein, the term “Network” refers to any public network such as the Internet or World Wide Web or any public or private network as may be developed in the future which provides a similar service as the present Internet.

As used herein, the term “Reviewer” refers to any entity (person, organization, etc.) that publishes a critique of a product, be they a consumer, industry analyst, etc.

As used herein, the term “User” refers to the entity who is utilizing the analytics and metrics computed by the CrowdChunk system server via the Query Interface Web Application as viewed from their mobile app or a web browser (e.g. on their laptop) in order to research a product that they are interested in.

### General User and Server Steps

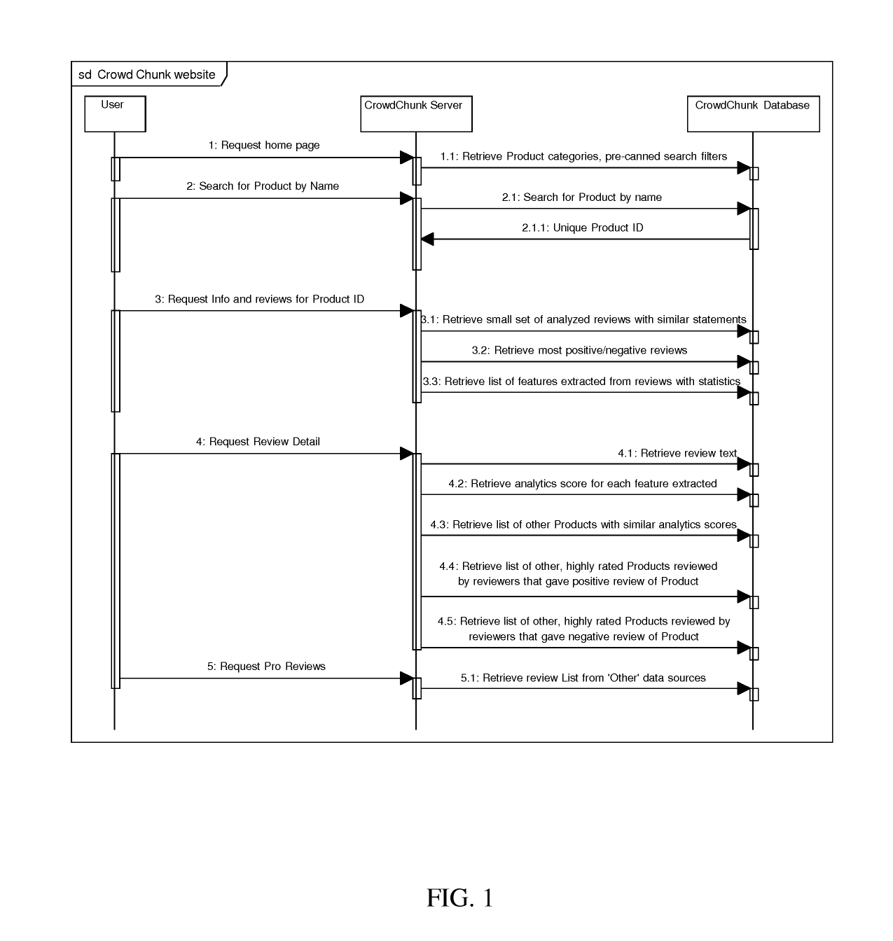

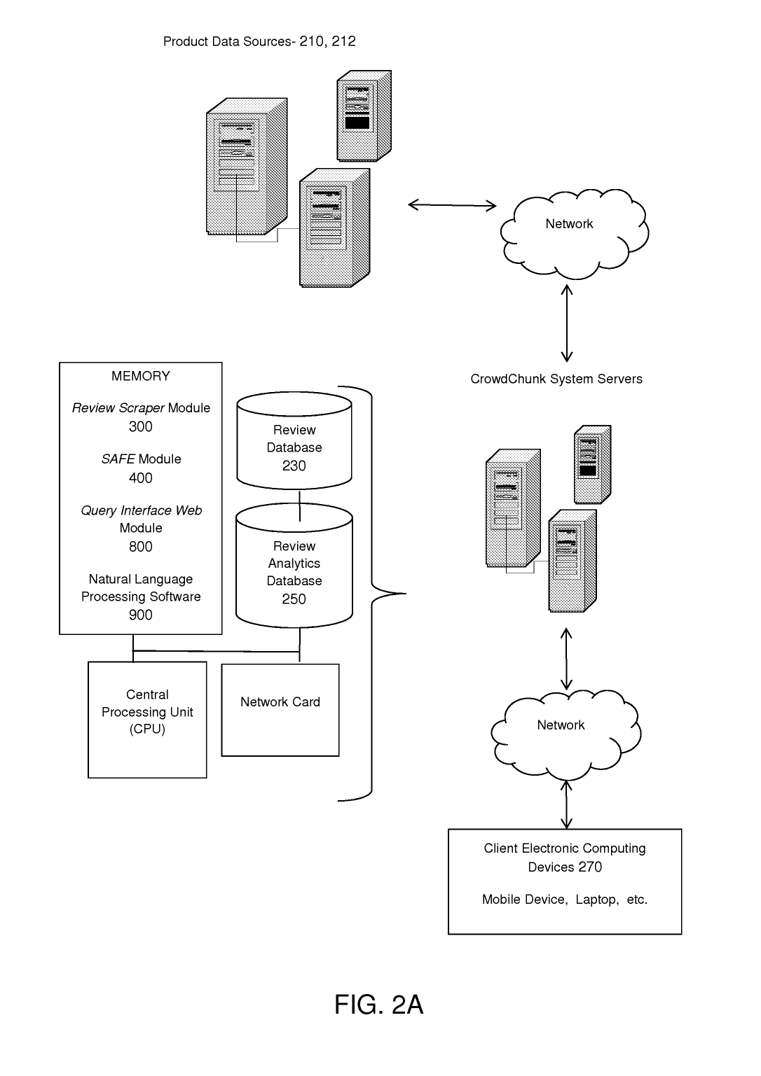

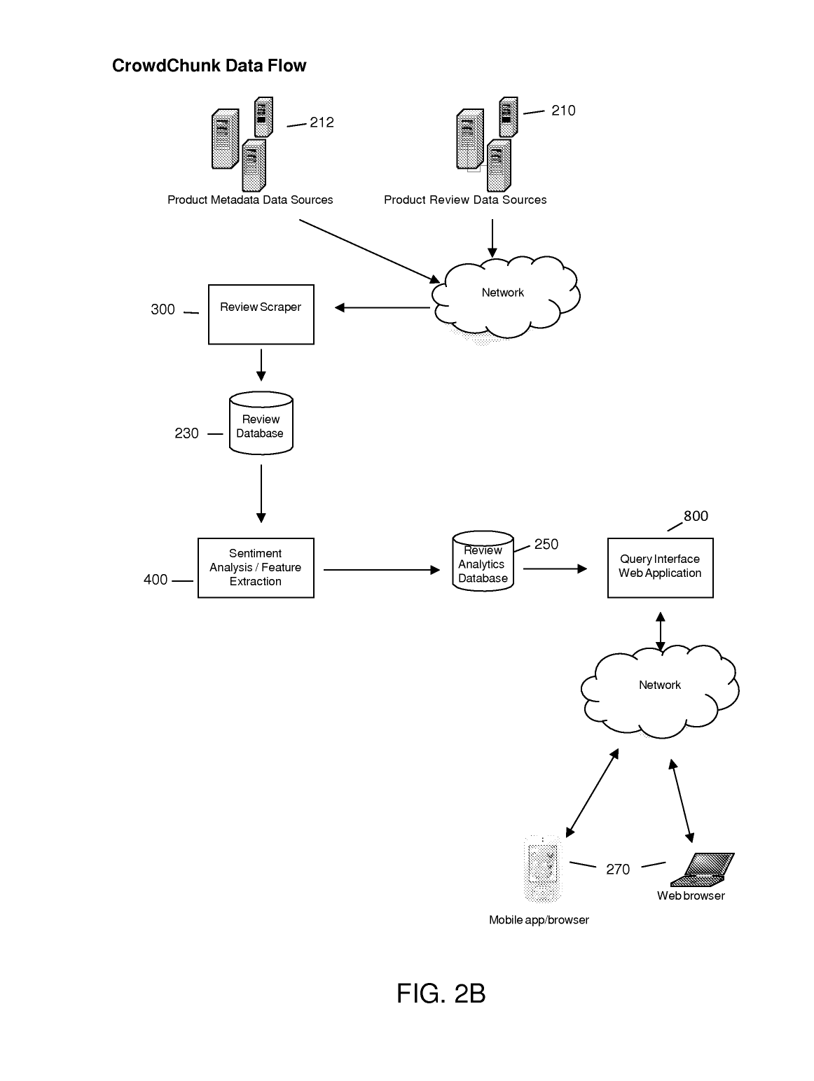

As illustrated in FIG. 1, the user interacts with the CrowdChunk system server via the Query Interface Web Application (FIG. 2B, 800) for the method of searching, selecting, and viewing the analytics summary of a particular product that they are interested in potentially purchasing. The user's steps are initiated (see FIG. 1, step 1) with the user navigating to the CrowdChunk home page on the mobile app (computer program product) or the webpage of the present invention. The CrowdChunk server will subsequently retrieve product categories and pre-canned search filters (e.g. “What's Trending”, “All-time Greats”, “On Sale”, etc.) to enable the user to search for a product by its commercial name or by a general category of intended use of the product or by a unique product identification (e.g. UPC) (FIG. 1, steps 1.1, 2, 2.1, 2.1.1). The user then requests information and reviews for the product of interest (FIG. 1, step 3), which the system server will retrieve from the Review Analytics Database (shown in FIGS. 2A & 2B, 250) comprising: i) a small set of analyzed reviews with similar statements (step 3.1); ii) the most positive/negative reviews (step 3.2); iii) a list of features extracted from reviews of statistics (step 3.3). The user may then request more details of a particular review (FIG. 1, step 4) and the system will retrieve: i) review text (step 4.1); ii) an analytics score for each feature extracted and computed by the CPU of the CrowdChunk server (step 4.2); and iii) a list of other products with similar analytics scores (step 4.3). The user can also exercise the “cross referencing” feature in step 4.4 of retrieving a list of other highly rated products reviewed by other user(s) (“reviewer(s)”) who gave positive reviews to the product the user is interested in. And in step 4.5 the user can retrieve a list of other highly rated products reviewed by other user(s) who gave a negative review to the product the user is interested in. The user may also request Professional Reviews written by experts (FIG. 1, step 5), and the system will retrieve a review list from “Other” data sources (e.g. blogs, online consumer and technical articles, websites, etc.) (step 5.1).

### System Architecture and Data Flow

FIG. 2A is a schematic diagram of the client-server system architecture of the present invention, and FIG. 2B is an illustration of the data flow from the exemplified online retailer, through processing on the system server, to searching and viewing by the user on a client computing device. The software and the computer program product of the present invention may comprise a cloud version and/or a hybrid version that uses cloud computing and conventional servers.

As illustrated in FIGS. 2A and 2B, the source of the product reviews comprise: 1) online product review data sources (210); and, 2) online product metadata data sources (212. Product review data sources (210) may comprise various online sources that provide reviews of products by consumers and industry professionals derived from, for example, blogs, online magazines, articles, consumer complaint websites, etc. . . . And online product metadata data sources (212) may comprise any source of information about one or more Products. This information would include common subject matter like Name, Description, Price, Category, and potentially more specific information depending on what kind of Product it is (e.g. version). Data from the product data resources 210 and 212 are downloaded via a network (e.g. Internet) to the CrowdChunk system server, which comprises one or multiple high speed CPU's (Central Processing Unit(s), primary memory (i.e. RAM), secondary storage device(s) (i.e. hard disk drives), and a means to connect the server with the network (e.g. a network card). The primary memory of the server as illustrated in FIG. 2A also comprises the Review Scraper Module 300, the Sentiment Analysis Feature Extraction (SAFE) Module 400, the Query Interface Web Application 800, and natural language processing software 900 (e.g. Freeling™—an open source natural language processing tool suite). The databases on the system server comprise the Review Database 230 for storing the pre-processed reviews pulled from the primary data source (e.g. source 210 and 212), and the Review Analytics Database 250 for storing the SAFE processed users' reviews.

The module and application programs, operating system and the database management programs may all run on the same computing device as in a traditional “main frame” type of configuration or several, individual yet interconnected computing devices as in a traditional “multi-tier client-server” configuration, as is well known in the art. The server system is coupled to the remote network (such as the Internet). The server system executes a (or multiple depending on the server system configuration) server program(s). The server system and the client program have communications facilities to allow client computers to connect to and communicate with the server program(s) such that the server program(s) can communicate with and exchange information with a multiplicity of user's client programs.

The User's client computing device may connect to the network via a variety of methods such as a phone modem, wireless (cellular, satellite, microwave, infrared, radio, etc.) network, Local Area Network (LAN), Wide Area Network (WAN), or any such means as necessary to communicate to the CrowdChunk system server connected directly or indirectly to the network (i.e. the Internet).

A user client computing device 270 comprises an electronic computing device with web browser capabilities, such as a mobile communications device, a desktop, a laptop, a netbook, and a mobile phone device (i.e. smartphone), etc. The user's client computing device is configured to communicate with the system server via the Internet to enable users to access the Query Interface Web Application 800 to search for and view summaries and metrics of product reviews by multiple reviewers.

### Computer Program Product

In an alternative embodiment, the users' client computing devices 270 may comprise a mobile electronic computing device (e.g. smartphone, tablet, etc.) with a computer program product of the present invention (e.g. “Query Interface Mobile App” module) installed within the device's memory so as to perform all or part of the functions of the present invention for researching the analytic summaries and metrics computed by the CrowdChunk system server's CPU.

The computer program product (e.g. “Mobile App”) of the present invention may comprise a native application, a web application, or a widget type application to carry out the methods of graphically displaying the content on a computing device screen. In a preferred embodiment, a native application is installed on the device, wherein it is either pre-installed on the device or it is downloaded from the Internet. It may be written in a language to run on a variety of different types of devices; or it may be written in a device-specific computer programming language for a specific type of device. In another embodiment, a web application resides on the system server and is accessed via the network. It performs basically all the same tasks as a native application, usually by downloading part of the application to the device for local processing each time it is used. The web application software is written as Web pages in HTML and CSS or other language serving the same purpose, with the interactive parts in JavaScript or other language serving the same purpose. Or the application can comprise a widget as a packaged/downloadable/installable web application; making it more like a traditional application than a web application; but like a web application uses HTML/CSS/JavaScript and access to the Internet.

In a preferred embodiment, all client electronic computing devices 270, will access the Query Interface Web Application, wherein the web app will deliver HTML pages optimized for each type of client platform. For example, iOS users will see rendered html pages optimized for navigation by the mobile device, laptop/PC users will see rendered html pages optimized for standard navigation by these respective devices based on the type of browser being used (standard detection of Internet Explorer, Google Chrome, Firefox, etc.). Additionally for iOS devices, the user will retrieve a downloadable app via the Internet to their mobile device so that s/he can easily access the CrowdChunk web app from an icon on their mobile device. This makes it easier than requiring the user to load the web browser and retrieve a bookmarked URL to the web app, but like a web application the downloadable app uses HTML/CSS/JavaScript and accesses the Internet. Likewise, laptop/PCs will always access the CrowdChunk web app via a standard browser.

The flow of data from the primary data sources of multiple reviews and review types (e.g. 210 and 212) to viewing by user on their client electronic computing device 270 is illustrated in FIGS. 2A and 2B and further disclosed infra.

### Review Scraper Module

The “Review Scraper” (FIGS. 2A and 2B, 300) comprises a software module stored on the CrowdChunk system server and executed by the system CPU for the purpose of retrieving product reviews from online data sources (e.g. online stores, blogs, online magazines and web sites, etc.). The Review Scraper module causes the system server to submit an HTTP request message to the server of the online product review data source 210 and/or the product metadata data sources 212 to pull all online reviews for all products, then process and store them in the Review Database 230 for use by the Sentiment Analysis and Feature Extraction (SAFE) module 400.

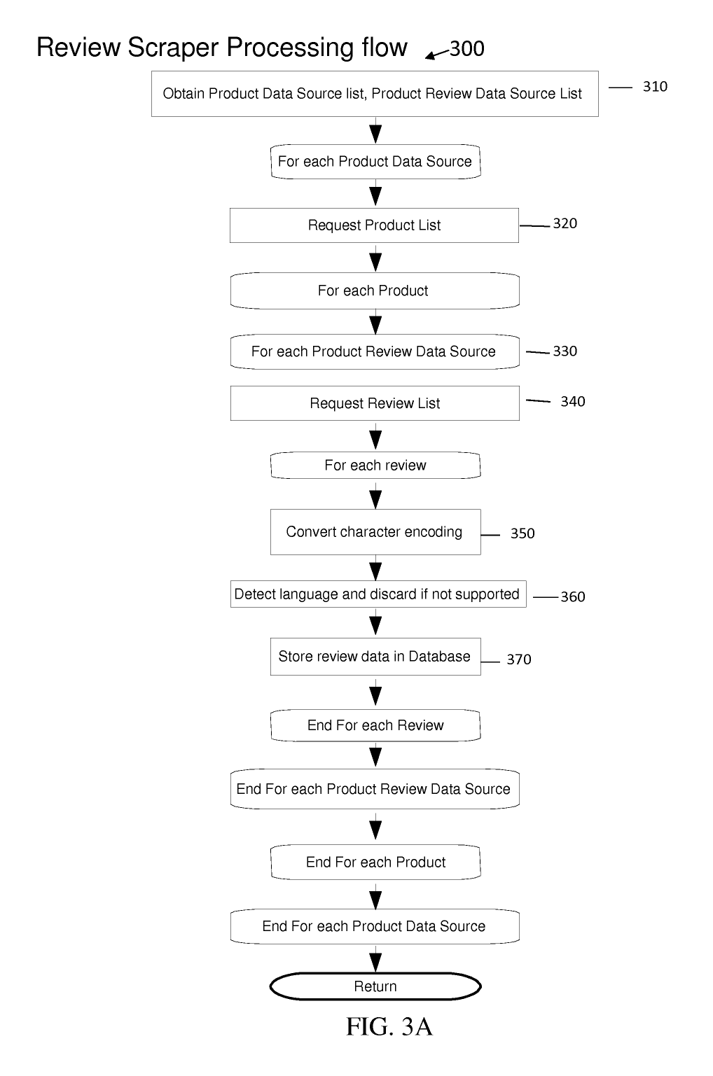

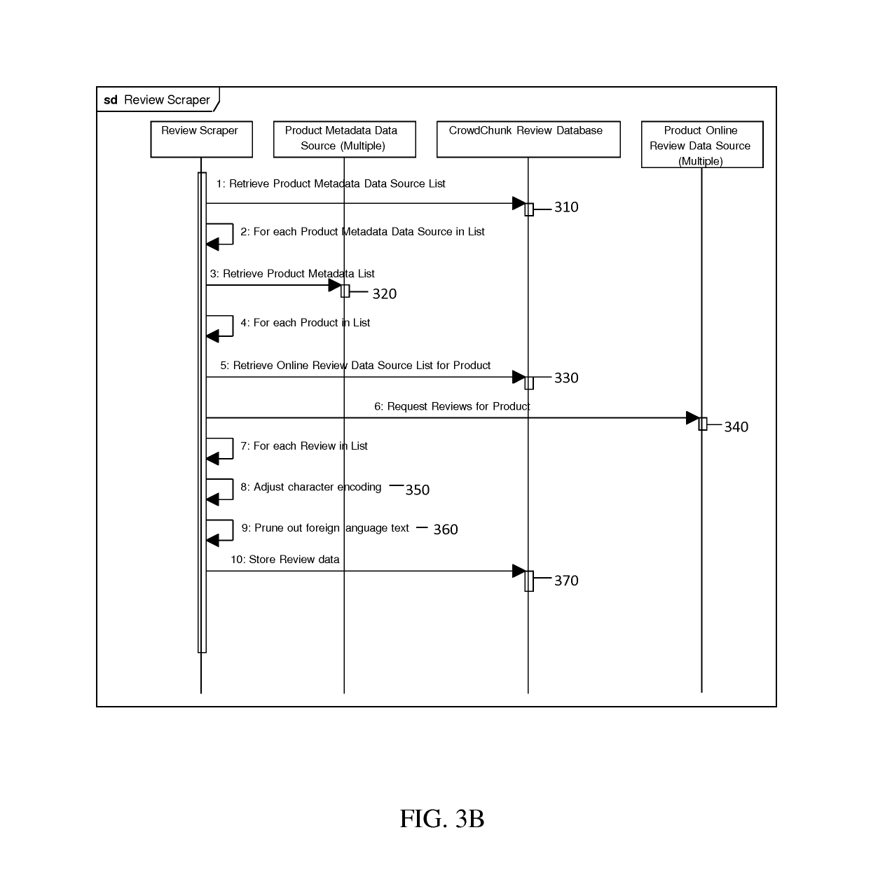

As detailed for a preferred embodiment in the flowchart for FIG. 3A, and the corresponding UML sequence diagram for all types of product sources in FIG. 3B, the Review Scraper process starts with the system server retrieving a Product Metadata Source List, e.g. from an online source (e.g. as illustrated in FIGS. 3A and 3B, step 310). For each Product Metadata Data Source, the system server requests a product list (step 320). Then the system server retrieves the product review data source list for each product on the list, request and retrieve online a review data source list for product (step 330) and requests the reviews for each product (step 340).

For each review, the system server-processor converts character encoding (step 350), detects language and discards if it is not supported (step 360), and stores the processed review in the Review Database 230. The data set describes a store's product list. It is generally exported from the store's product database and “published” online or made available for download at regular intervals (e.g. daily). The data may also be available in two different formats—either as the files necessary to build a relational database or as stand-alone flat files that are country and media dependent. This list will be refreshed periodically as new products are submitted to the online store frequently and this list grows over time. As per step 350, for each review retrieved the CPU will adjust or convert the character encoding of all reviews from ISO/IEC 8859-1 to UTF-8 to ensure compatibility with the Freeling module used in analytics processing. The system server will then remove all foreign language and other text if it is not translatable by the Scraper (step 360). The “edited” review data is then stored in the Review database 230 (step 370), and the process is repeated for each review retrieved from the product list in step 320. The system will then repeat steps 350-370 for each review pulled from each Product Review Data Source.

The Review Scraper Module will likewise repeat the process for each product review data source (steps 330-370); and then for each product (steps 320-370); and then for each product data source (310-370).

### Sentiment Analysis and Feature Extraction (SAFE) Module

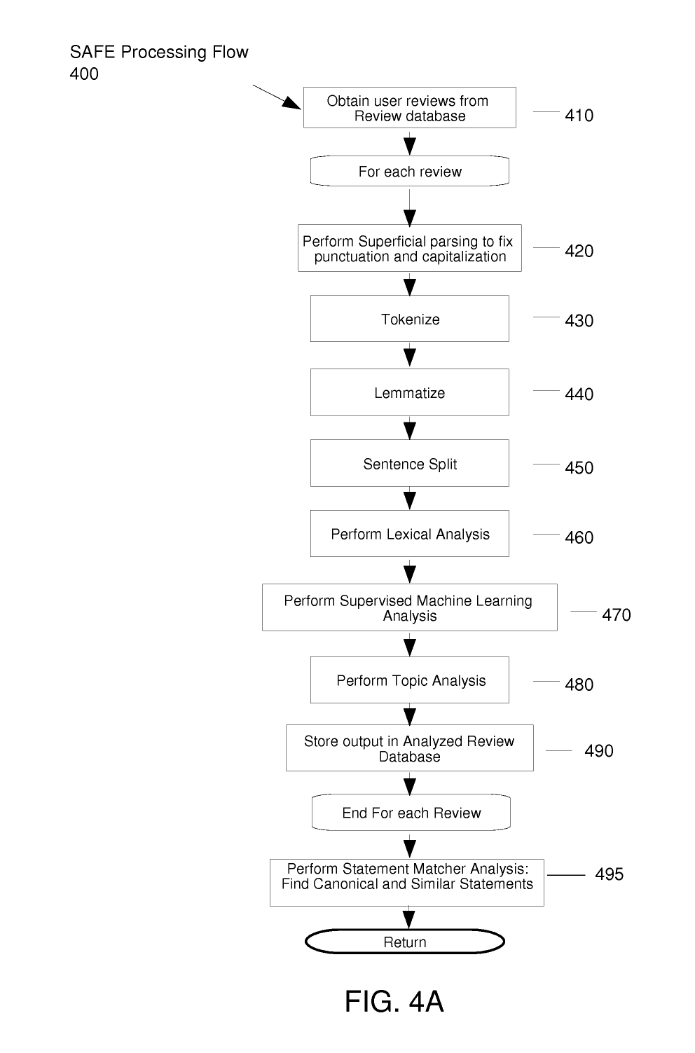

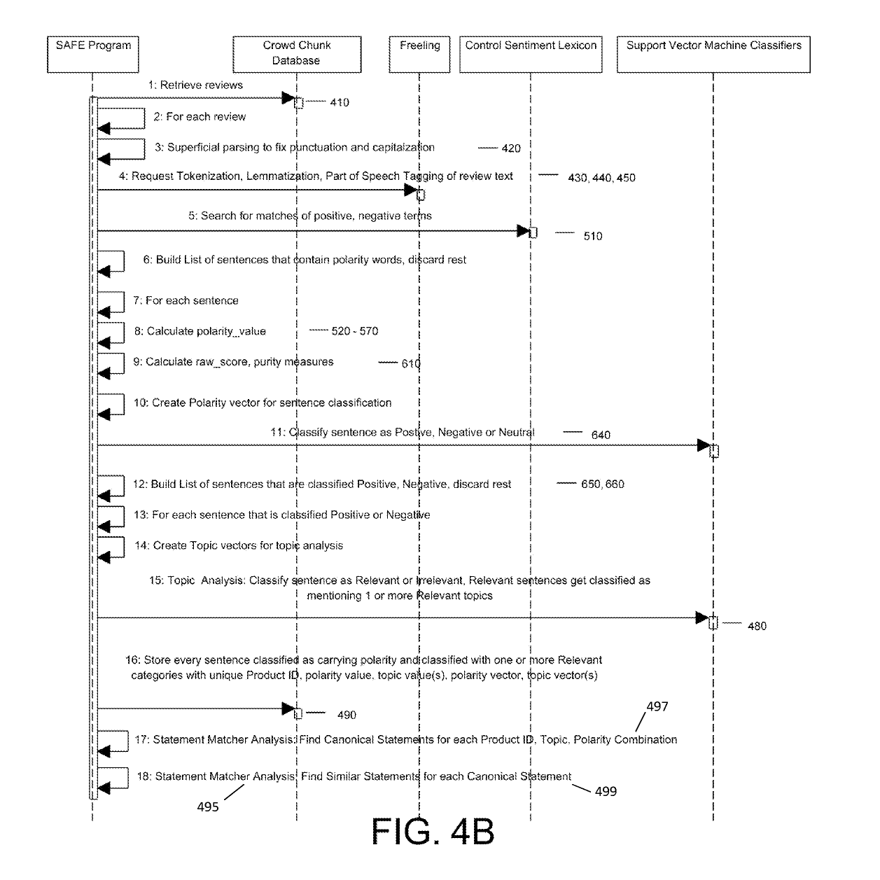

The SAFE module analyzes the reviewers' evaluations stored in the Review database 230 via the flowchart steps shown in FIG. 4A, and the corresponding UML sequence diagram in FIG. 4B. As per step 410, the CrowdChunk server retrieves users' reviews stored in the Review database 230 for all products listed in the Product List. For each review pulled from the Review database 230, the SAFE module performs superficial parsing to fix punctuation and capitalization of the text within the review (step 420) to enable natural language processing software to recognize sentences. In a preferred embodiment, the Freeling natural language processing software is utilized, although it would be readily apparent to the skilled artisan how and which other types of language processing software to use with the present invention, such as LingPipe, CLAWS, Tnt, and MorphAdorner.

The CPU of the CrowdChunk server subsequently performs part-of-speech tagging on the review text processed in step 420 utilizing the language processing software. The process comprises marking up a word in a text of the review as corresponding to a particular part of speech (e.g. noun, verb, adjective, etc.) based upon its common known definition, as well as its context within the review, such as its relationship with adjacent and related words in a phrase, sentence, or paragraph within the review. In order to accomplish this, the natural language processing software performs tokenization (step 430) and lemmatization (step 440). During tokenization, the stream of text within the review is broken up into words, phrases, symbols and other elements known as “tokens”. During lemmatization, the CPU determines the “lemma” of the words within the review, which is the canonical, dictionary, or citation form of a set of words (e.g. “run” is the lemma for runs, ran, running). The CPU performs an additional step, sentence splitting (step 450), during which the tokenized text is assembled with the help of the POS-tags assigned to it into sentences for use in step 460—Lexical Analysis.

By way of exemplification for steps 430-450: Freeling is loaded into the CrowdChunk system server memory by executing it in the server mode: (analyze -f/usr/local/share/freeling/config/en.cfg --nonec --nonumb --noner --noloc --noquant --nodate --flush --server --port 50005 &). Then every review that is output by the preprocessing step described in step 420 is sent to the Freeling process running in server mode in order to POS-tag it. Freeling output is parsed and structured as follows: 1) one list of lists with the tokenized words of every sentence in the review; 2) one list of lists with the tokenized lemmas of every sentence in the review; and 3) one list of lists with the tokenized POS-tags of every sentence in the review.

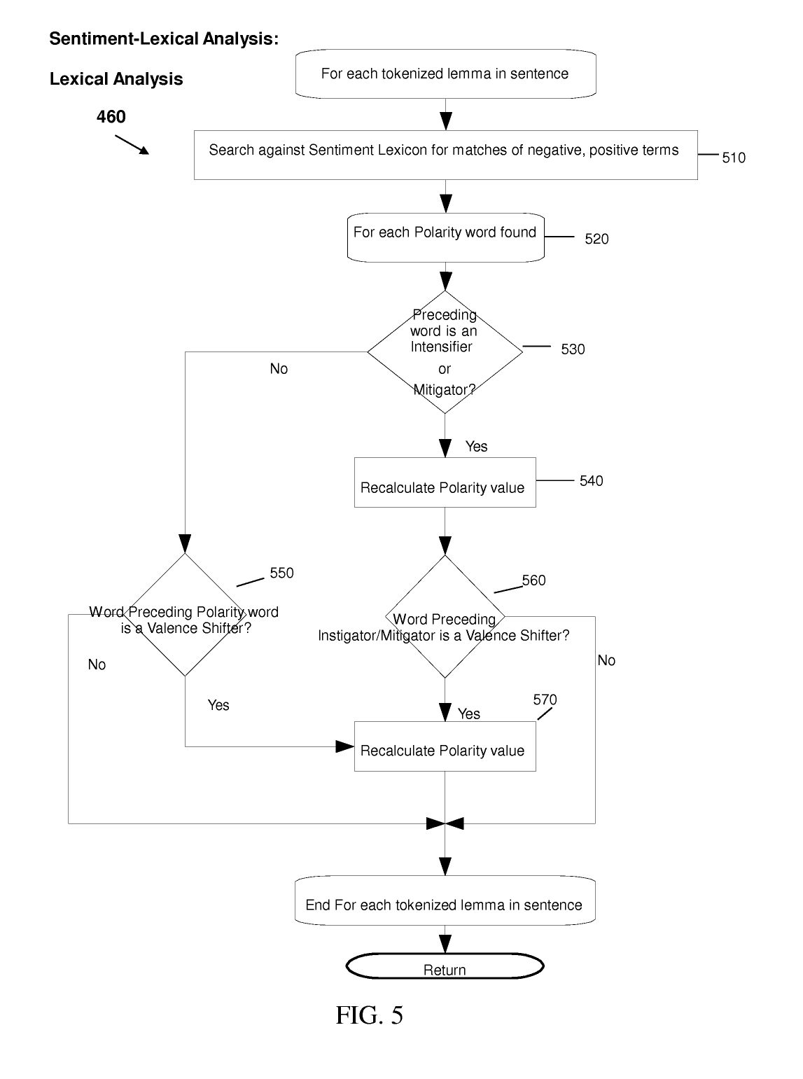

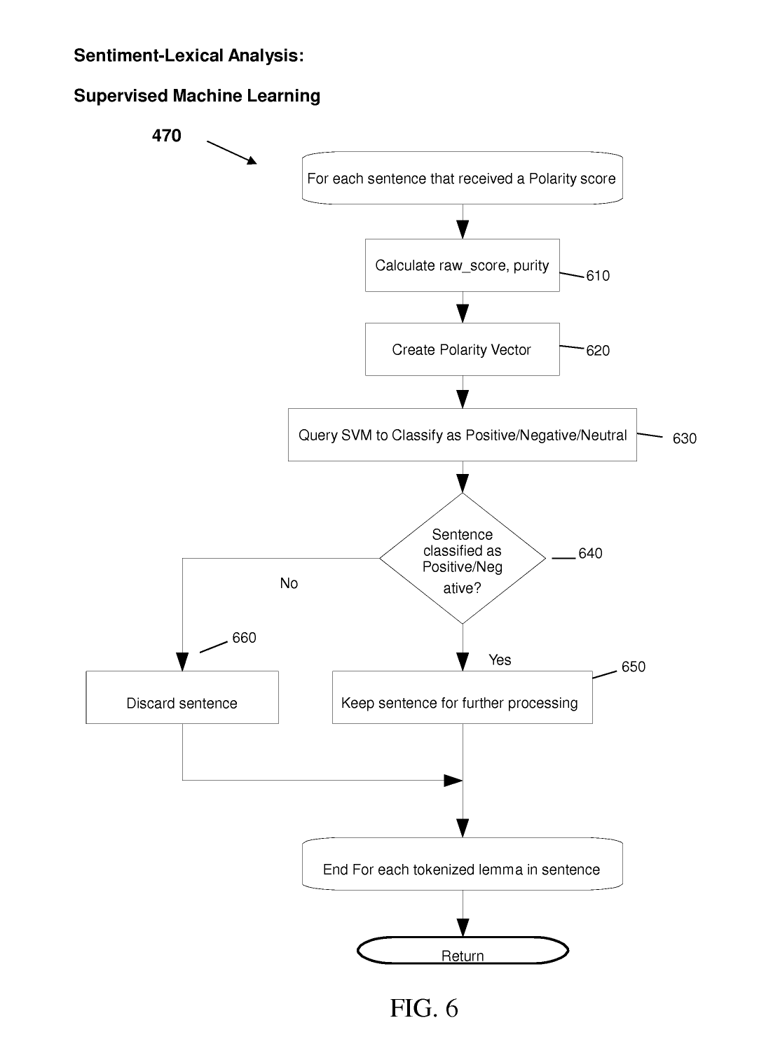

After processing the reviews by the natural language software 900, sentiment-lexical analysis is performed on the output in step 460—Lexical Analysis (see the flowchart in FIG. 5), and step 470—Supervised Machine Learning Analysis (see the flowchart in FIG. 6). Following this, the output of the Topic Analysis is stored in step 490 in the Review Analytics Database 250 and comprises the classification of every sentence as carrying a polarity. Every sentence is also classified into one or more Relevant categories with unique Product ID, polarity value, topic value(s), polarity vector, and topic vectors. To initiate the Lexical Analysis, a controlled sentiment lexicon is created manually. This lexicon includes English lemmatized nouns, verbs, adjectives and adverbs that are manually labeled as either carrying positive or negative polarity (e.g. positive review or negative review of the product). A controlled list of English intensifiers, mitigators and valence shifters is manually compiled. Intensifiers are words that amplify the meaning of the word they modify (e.g. “very”, “greatly”, etc.). Mitigators are words that mitigate the meaning of the word they modify (e.g. “mildly”, “barely”, etc.). And valence shifters are words that revert the meaning of the word they modify (e.g. “not”, “no”, etc.). The mitigators and intensifiers are manually assigned a value that represents their mitigation or intensification power.

As illustrated in FIG. 5, the Lexical Analysis Sub-Module 460 then analyzes the list of tokenized lemmas for every sentence outputted by the sentence split processing described in step 450 in order to find matches of the negative and positive terms in the sentiment lexicon created supra (FIG. 5, step 510). To calculate the polarity value, occurrences of negative terms get assigned a value of −1 and positive ones, a value of 1 (step 520). For each of these occurrences, the word that precedes them is searched in the intensifiers and mitigators list (step 530). If no intensifier or mitigator is found preceding a polarity word, the preceding word is checked to determine whether it is a valence shifter or not (step 550). If it is a valence shifter, the polarity value of the matched sentiment word is recalculated as follows: (polarity_value=polarity_value*−1) (step 570).

If an intensifier or mitigator was found in step 530, then the polarity value of the matched sentiment word is recalculated as follows: (polarity_value=polarity_value+(polarity_value*intensification/mitigation_value)) (step 540), the word that precedes the intensifier/mitigator is checked to determine whether it is a valence shifter or not (step 560). If it is a valence shifter, the polarity value resulting from taking into account the intensification/mitigation is shifted as described by the previous formula: (polarity_value=polarity_value*−1) (step 570). After this process is completed, a list of sentences that contain polarity words gets extracted. The rest of sentences that did not match any polarity term get discarded.

The sentences containing polarity words from the Lexical Analysis Sub-Module 460 are then fed into the Supervised Machine Learning Module (FIG. 4A, step 470) for which the flowchart of steps is found in FIG. 6. For each of these sentences a set of measures is calculated by the CrowdChunk CPU in step 610: 1) “raw_score”, which is the score that results from adding all the values of the identified lexical occurrences; and 2) “purity”, which represents the ratio (“raw_score”/(absolute_score)), wherein “absolute_score” is calculated by adding the absolute value of all the values of the identified lexical occurrences.

Once the “raw score” and “purity” value for a review are calculated by the CPU, the SAFE module (and the Supervised Machine Learning subroutine) creates a “polarity vector” for each sentence in a review that contains the following dimensions (step 620), wherein “−1” means the previous sentence, and “+1” means the next sentence:
x0=sentence raw score
x1=sentence purity score
x2=sentence−1 raw score
x3=sentence−1 purity score
x4=sentence−1 absolute raw score
x5=sentence−1 objectivity
x6=sentence+1 raw score
x7=sentence+1 purity score
x8=sentence+1 absolute raw score
x9=sentence+1 objectivity
x10=review raw score
x11=review purity
x12=review user assigned star
   Annotations “x5” and “x9” refer to a value that is recorded when matching polarity terms from the lexicon in every sentence. If no polarity term gets matched, the sentences get assigned a value of 0; otherwise it gets assigned a value of 1 in order to keep track of neutral sentences found in the review. Annotations “x10” and “x11” are calculated as follows:
x10: sum of the raw score of all the sentences in a review
x11: sum of the purity score of all the sentences in a review

Once vectors “x0” through “x12” have been created for every sentence in a review, the Supervised Machine Learning subroutine proceeds to classify each potential candidate sentence as Positive, Negative or Neutral (step 630). This classification is achieved using a Support Vector Machine (SVM) classifier, which was previously, trained using a manually labeled set of sample sentences processed by the Lexical analysis module (step 640). Sentences classified by the SVM as either Positive or Negative are kept for further processing (step 650). Sentences classified as Neutral get discarded (step 660).

### Topic Analysis

Following Supervised Machine Learning subroutine 470, the SAFE module performs the “Topic Analysis” subroutine (FIG. 4A, step 480). During Topic Analysis each sentence identified as negative or positive in Supervised Machine Learning is further analyzed by a set of Support Vector Machine classifiers to determine the topics that it mentions. Exemplified topics were defined as a hierarchy as follows:
Irrelevant
Relevant
   Enjoy ability
   Graphics/UI
   Ease of use/Performance
   Price

Each sentence identified as negative or positive is matched against a set of precompiled lists of lexical features and transformed into a series of vectors for each of the SVM classifiers to process them. The precompiled lists of lexical features were created during the training stage by analyzing and comparing the set of words that tend to occur more prominently for each of the topic categories. Classifiers were trained using a manually labeled set of sentences to make the following distinctions:
Irrelevant vs. Relevant
Enjoy ability vs. Non-enjoy ability
Graphics/UI vs. Non-Graphics/UI
Ease of use/Performance vs. Non-Ease of use/Performance
Price vs. Non-Price

With this set of classifiers, sentences get classified as being “Relevant” or “Irrelevant”. If they get classified as “Relevant”, then they get classified as mentioning any of the topics listed under “Relevant” in the hierarchy supra (i.e. Enjoy ability, Graphics/UI, Ease of use/Performance, and Price).

Finally, every sentence is classified as carrying polarity and classified with one or more of the categories under “Relevant”, and is stored along with its unique application ID (AppID), polarity value, topic value(s), polarity vector and topic vector(s) in the Review Analytics Database.

### Statement Matcher

The Statement Matcher (see FIG. 4A, 495) refers to the process of: 1) finding one or more Canonical Statements within a Product's review dataset that contain comments, observations, or sentiments statistically likely to be shared by multiple reviews in the dataset (FIG. 4B, 497), and, 2) determining the subset of reviews that made statistically similar statements to these Canonical Statements (FIG. 4B, 499). Example output of the Statement Matcher could be embodied as follows:
Canonical Statement 1: “Great graphics!”
24 reviews were found to have made similar statements.
Canonical Statement 2: “My kids loved it”
13 reviews were found to have made similar statements.

### 1—Finding Canonical Statements

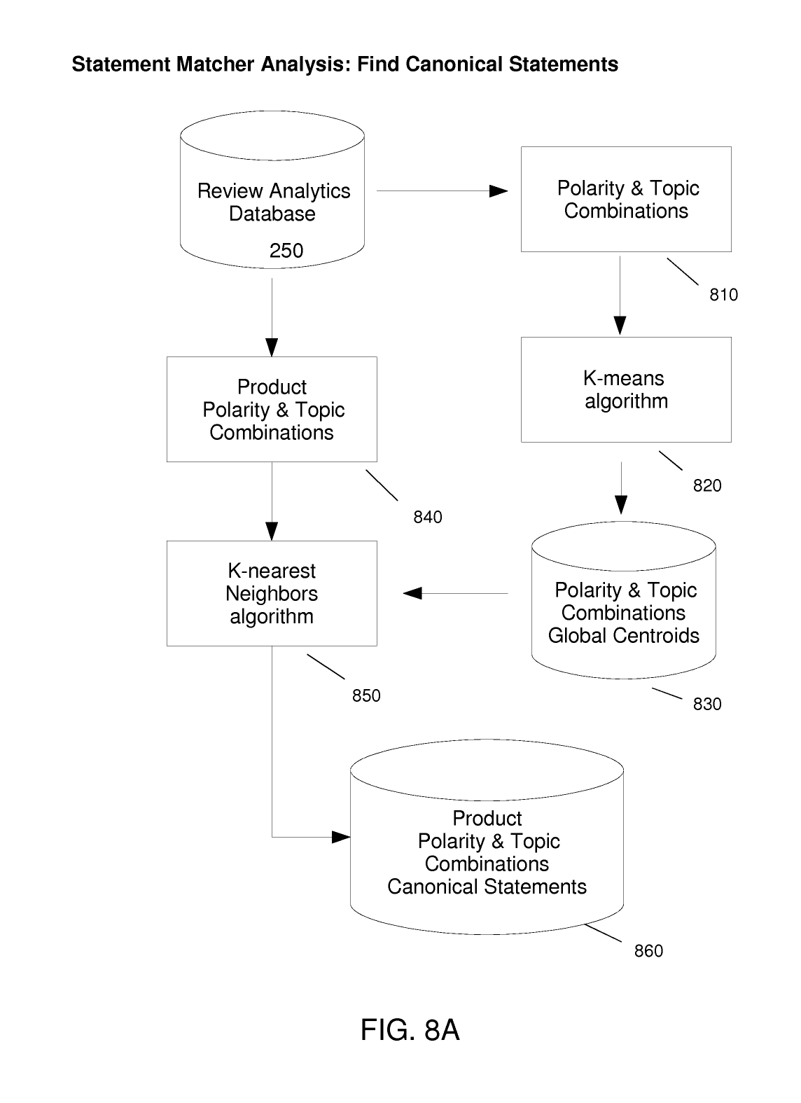

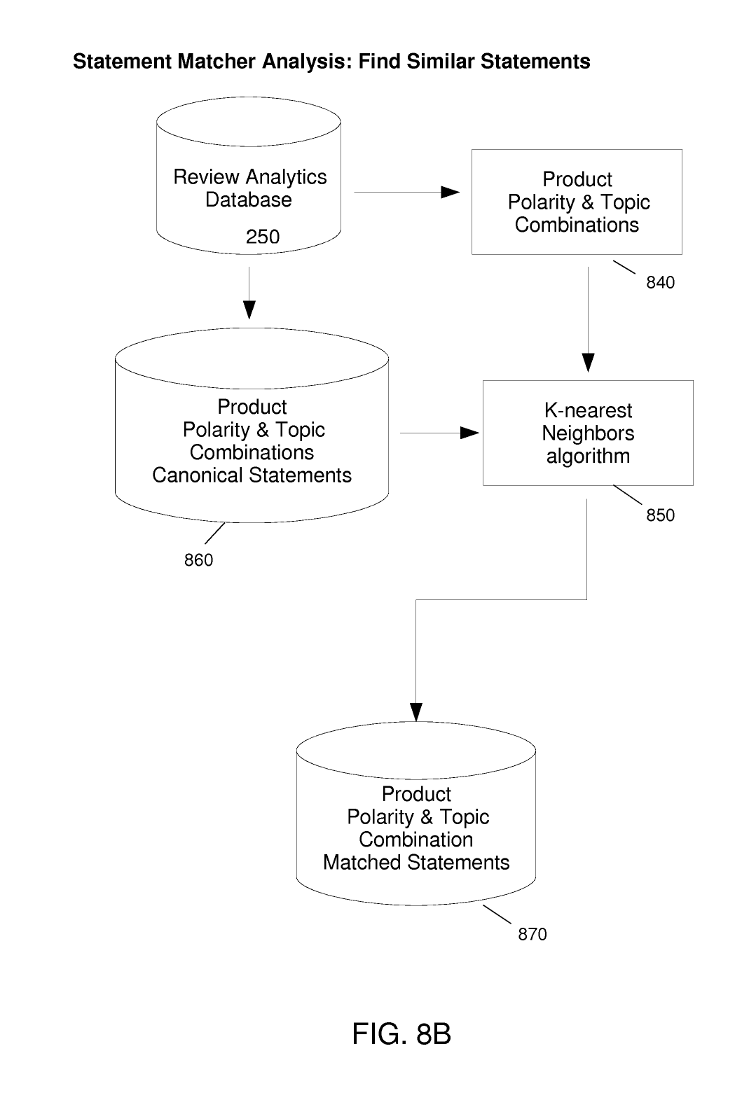

The Statement Matcher has two stages for finding Canonical Statements, as illustrated in the flowchart of FIG. 8A. First it finds the global centroid—the centroid for all Product Reviews of a specific Product Category—for each valid combination of Topic and Polarity (ex. Topic=Enjoyability, Polarity=Positive). The centroid is calculated mathematically using the concatenation of the Polarity Vectors and Topic Vectors calculated during the Topic and Polarity Analyses described above.

The Statement Matcher identifies all Statements classified with the same Topic/Polarity combination (step 810) and runs the k-means algorithm (step 820) to find the centroid of the vector space defined by that subset.

Second, once global centroids (step 830) have been found, the Statement Matcher iterates over the Product List and identifies all the statements associated with each Product for every valid combination of topic and polarity (step 840). The concatenated Polarity and Topic vectors of the identified statements are analyzed using the k-nearest neighbors algorithm (step 850) to find the Statement that is closest to the global centroid found in the previous stage (step 860).

### Exemplification:

1. The global centroid for Product=‘ABC Widgets’, Topic=Enjoy ability and Polarity=Positive is identified.
2. All the Statements for Product=‘ABC Widgets’, that have been tagged as Topic=Enjoy ability, Polarity=Positive are identified.
3. Apply the k-nearest neighbors algorithm to all Statements identified in the previous step to determine which one of those Statements is the closest to the global centroid.
4. The Statement identified in previous step is tagged as the Canonical Statement for that Product/Topic/Polarity combination.

### 2—Finding Similar Statements

The flowchart in FIG. 8B discloses the computer steps for determining the subset of reviews that made statements similar to the Canonical Statement. For each Product, the Statement Matcher algorithm re-runs the k-nearest neighbors algorithm (FIG. 8A, step 840 & 850), but in this case the reference Statement used is the previously determined Canonical Statement (FIG. 8A, step 860). The vector space defined by the concatenated Polarity and Topic vectors of each valid combination of topic and polarity gets analyzed using as reference the Canonical Statement to find which Statements are the most statistically similar.

The most statistically similar statements matched on the previous step are subsequently filtered using a fuzzy matching algorithm that compares their tokenized sentences to the Canonical Statement's tokenized sentence and selects only those statements that have a fuzzy matching score above a predefined threshold, that is which are superficially most similar to the Canonical Statement (step 870).

### Query Interface Web-Based Application

From the client electronic computing device 270 in FIG. 2B, the user may search for and view the SAFE processed reviews by navigating via the Internet to a web-hosted site displaying the Query Interface Web Application 800. It is also noted that the user may interact with the Query Interface Web Application by utilizing the computer product of the present invention installed as an App on their mobile electronic computing device.

The Query Interface Web Application 800 enables the user to search for products based on its commercial name or category of use or tangible item (i.e. Games, Productivity tools, Cameras, etc.). Upon the user entering a search for a particular product or a category of product's, the Query Interface Web Application will retrieve any pertinent information stored on the CrowdChunk server's Review Analytic Database 250 in FIG. 2B and display it on the user's GUI. The display may comprise a variety of formats to disclose the users' reviews extracted from various data sources and processed by the SAFE module. In a preferred embodiment, the user's display may comprise the following features for a search, summary, and a detailed page of analytics for each Product:
1) Request Search Page:
   a) Search text entry field; and,
   b) A list of links to categories and/or pre-canned search filters (e.g. “What's Trending”, “All-time Greats”, “On Sale”, etc.);
2) Search Summary Page:
   a) Search text entry field at top with drop down select lists for iPhone/iPad, Free/Paid, and Category lists;
   b) Search results displayed in 3×3 grids with numbered links to other pages of results; and,
   c) Each Product in result group with its Name, Price, Icon, 0-5 star rating, count of ratings, screen shot, link to iTunes® and link to “Info & Reviews” (see infra).
3) “Info and Reviews” Page:
   a) Search field at top;
   b) Product information row below (i) comprising Product's Icon, Name, Screen Shots, link to online store (e.g. iTunes, Amazon);
   c) Collate feature comprising: a list of 3 pull quotes culled from user reviews along with a sentence like, “[x] users out of [y] made a similar statement.” Each quote has link to the Review Detail Page;
   d) A list of features extracted from reviews with average score next to them (e.g. 80% positive, Easy to Use 60% positive, Fun factor 40% positive);
   e) The most positive/negative reviews: list of 2 pull quotes culled from users that system determines are most positive/negative (e.g. “Most positive review: ‘review content’”, “‘Most negative review: ‘review content’”); and,
   f) A link to review feed, with some choices for how to order the results by, for example, the most recent/oldest date posted, by highest/lowest/Easy, highest/lowest Easy to Use, highest/lowest Fun Factor, etc.
4) A Review Detail Page (shown when user clicks on reviews from either the collate feature, most positive/negative quotes, or the Review Listing):
   a) Score for each feature extracted. For example, a very positive review may have: Positive; Ease of Use: Positive; Fun Factor: Negative.
   b) Short cross-reference list of other Products (with name/icon) that same reviewer gave a very positive review for extracted features (i.e. list contains reviews with ratings: Positive and/or Easy to Use:
   Positive and/or Fun Factor: Positive). Clicking on one of these brings up the Review Detail Page for this other Product.
5) Pro Reviews Page (shown when user clicks on review from either a collate feature, most positive/negative quote, or the Review Listing):
   a) Listing of reviews extracted by Review Scraper from ‘professional’ data sources other than Product store repository (e.g. Apple review repository);
   b) Displays name of data source (blog, online magazine, website, etc.) with clickable link to the original review; and,
   c) Display review text.
6) A “Product Review Cross-Referencing Positive” feature comprising a list of other products that a reviewer who gave a high rating for the product of interest by the user, also gave a high rating to. If any product on the list is in the same category as the type of product the user is searching for, then the user is able to compare the features between the products and possibly find another product with similar desirable features, at perhaps a better price and/or possessing additional, desirable features. This is accomplished by querying the Review Analytics Database for all highly rated products reviewed by the same reviewers that gave the product of interest a high rating. The result set from this query contains all analytics results for each highly rated product, respectively, as required for display in the web application.
7) A “Product Review Cross-Referencing Negative” feature comprising a list of other products that a reviewer gave a positive rating for, while giving a negative rating to the product of interest by the user. By comparing the two, the user may be able to identify another product with improved performance and/or features as compared to the product that they were originally researching on the system. This is accomplished by querying the Review Analytics Database for all highly rated products reviewed by the same reviewers that gave the product of interest a low rating. The result set from this query contains all analytics results for each highly rated product, respectively, as required for display in the web application.

It is noted that the outline supra is only one exemplification of the present invention's Query Interface Web Application's functionality. One of skill in the art would readily know of other ways to utilize the system of the present invention to prompt the user for search terms, then extract and present the SAFE processed information from the Review Analytics Database, as well as to perform other types of data analysis on multiple reviewers' summaries stored in the Review Database.

### CONCLUSION

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowcharts and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “preferred embodiment”, “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

What is claimed is:

1) A networked based computing system for retrieving, analyzing, and displaying multiple reviews of consumer products, wherein the reviews are posted on the Internet, to enable a user to search for and view analyzed summaries of the reviews, the system comprising:
a) a remote server, comprising;
i) a central processing unit for retrieving, computing, and storing analyzed summaries of the reviews;
ii) a review database for storing records of written reviews of products retrieved by the central processing unit from the Internet;
iii) a review analytics database for storing records from the review database that are processed for use by a natural language processing module;
iv) a natural language processing module for performing tokenization, lemmarization, and sentence splitting computing processes on the reviews;
v) a review scraper module for retrieving users' reviews from online data sources, preprocessing them for compatibility with the natural language processing module, and storing them within the reviews database;
vi) a sentiment analysis feature extraction processing module for processing the reviews stored within the reviews database to generate a profile for each mobile application comprising analytical summaries, and storing the profile within the review analytics database;
vii) a query interface web module to enable searching by a user the profiles stored on the review analytics database and viewing the analytical summaries;
b) two or more client computers comprising a graphical user interface for communicating with said system server to enable a user to search for a particular product, and/or a class of products, and view the analyzed summaries of the reviews for the product(s); and,
c) a network for transmitting electronic communications between the client computers and the remote server.

2) The networked based computing system of claim 1 wherein said products comprise, digital media purchased for online streaming, downloading, accessing via the Internet, and/or physically shipping to the user.

3) The networked based computing system of claim 2, wherein digital media comprises: eBooks; paper books bought online and shipped; podcasts; digital movies, music, video games, audio books, TV shows, and desktop computer applications, that are streamed online or downloaded; and, DVD's copies purchased online and shipped to the user (e.g. DVD's).

4) The system of claim 1, wherein said analytical summaries comprise one or more of:
a) a list of two or more quotes from the reviewers and displaying how many reviewers made a similar comment about the product;
b) a list of two or more quotes from the reviewers that the central processing unit has determined are the most positive and most negative comments about the product;
c) a list of features extracted from the reviews and displaying the average score of each feature as calculated by the central processing unit;
d) a review detail webpage for each product comprising:
i) a score calculated by the central processing unit for features of the product that were reviewed, wherein said features are labeled either “positive” or “negative”;
ii) reviews of other cross-referenced products that the central processing unit has determined: 1) that a reviewer(s) who gave a positive rating to the application, also rated highly; and 2) that reviewer(s) who gave a negative rating to the application, also rated highly; and,
e) a professional reviews webpage listing reviews extracted from products professionals and links to the original review written by the professional.

5) The system of claim 1, wherein said reviews stored within the review database are preprocessed by the review scraper module directing the central processing unit to adjust and convert the review's character encoding to ensure compatibility with the natural language processing module, and to remove all foreign language and other text if it is not translatable.

6) The system of claim 5, wherein said review scraper module performs superficial parsing to fix punctuation and capitalization of the text within the reviews to enable the natural language processing software to recognize sentences.

7) The system of claim 1, wherein the sentiment analysis feature extraction processing module utilizes lexical analysis, supervised machine learning analysis, and topic analysis to compute the analytical summaries.

8) The system of claim 7, wherein the sentiment analysis feature extraction processing module further directs the central processing unit to calculate the average score of the product's rated features.

9) A computer implemented method for retrieving, analyzing, and displaying reviews of consumer products available on the Internet, the product to enable a user to search for and view the analyzed summaries of the reviews, comprising processor(s) on a system server:
a) retrieving users' reviews from online data sources, preprocessing them for compatibility with a natural language processing module, and storing them within a reviews database;
b) processing the reviews stored within the reviews database using lexical analysis, supervised machine learning analysis, and topic analysis to generate a profile for each product, and storing the profile within a review analytics database;
c) searching by a user from their electronic computing device the profiles stored on the review analytics database and viewing analytical summaries of features of the product; and,
d) clicking by a user a link within the product's displayed profile to the original online source for purchasing the product.

10) The computer implemented method of claim 9, wherein the products comprise digital media purchased for online streaming, downloading, accessing via the Internet, and/or physically shipping to the user.

11) The computer implemented method of claim 10, wherein the digital media comprises eBooks; paper books bought online and shipped; podcasts; digital movies, music, video games, audio books, TV shows, and desktop computer applications, that are streamed online or downloaded; and, DVD's copies purchased online and shipped to the user (e.g. DVD's).

12) The computer implemented method of claim 9, wherein said analytical summaries comprise a list of two or more quotes from the reviewers and displaying how many reviewers made a similar comment about the product.

13) The computer implemented method of claim 9, wherein said analytical summaries comprise a list of two or more quotes from the reviewers that the central processing unit has determined are the most positive and the most negative comments about the product.

14) The computer implemented method of claim 9, wherein said analytical summaries comprise a review detail webpage for each product displaying:
a) a score calculated by the central processing unit for features of the product that were reviewed, wherein said feature is labeled either “positive” or “negative” and comprise enjoy ability, and quality, ease of use and performance, and price; and,
b) reviews of other cross-referenced products that the central processing unit has determined: 1) that a reviewer(s) who gave a positive rating to the product, also rated highly; and 2) that reviewer(s) who gave a negative rating to the product, also rated highly.

15) The computer implemented method of claim 9, wherein said analytical summaries comprise a professional reviews webpage listing reviews extracted from product professionals and links to the original review written by the professional.

16) A computer program product for retrieving, analyzing, and displaying reviews of consumer products available on the Internet, and embodied in a non-transitory computer readable medium that, when executing on one or more computer processors, configure the processor(s) to, performs the steps of:
a) retrieving users' reviews from online data sources, preprocessing them for compatibility with a natural language processing module, and storing them within a reviews database;
b) processing the reviews stored within the reviews database using lexical analysis, supervised machine learning analysis, and topic analysis to generate a profile for each product, and storing the profile within a review analytics database;
c) searching by a user from their electronic computing device the profiles stored on the review analytics database and viewing analytical summaries of features of the product; and,
d) clicking by a user a link within the application's displayed profile to the original online source for purchasing the product online.
e) wherein the products comprise digital media purchased for online streaming, downloading, accessing via the Internet, and/or physically shipping to the user.

17) The computer program product of claim 16, further comprising a mobile application running on a user's mobile electronic computing device enabling the user to search for and view profiles of products stored on the review analytics database comprising analytical summaries of features of the products.

18) The computer program product of claim 17, wherein the analytical summaries viewed by the user on their mobile electronic computing device comprises one or more of:
a) a list of two or more quotes from the reviewers and displaying how many reviewers made a similar comment about the product;
b) a list of two or more quotes from the reviewers that the central processing unit has determined are the most positive and most negative comments about the product; and,
c) a list of features extracted from the reviews and displaying the average score of each feature as calculated by the central processing unit, wherein said features comprise enjoy ability, and quality, ease of use and performance, and price.

19) The computer program product of claim 17, wherein the analytical summaries viewed by the user on their mobile electronic computing device comprises a review detail webpage for each product displaying:
a) score calculated by the central processing unit for features of the product that were reviewed, wherein said features are labeled either “positive” or “negative” and comprise enjoy ability, quality, ease of use, performance, and price; and,
b) reviews of other cross-referenced applications that the central processing unit has determined: 1) that a reviewer(s) who gave a positive rating to the application, also rated highly; and 2) that reviewer(s) who gave a negative rating to the application, also rated highly.

20) The computer program product of claim 17, wherein the analytical summaries viewed by the user on their mobile electronic computing device comprises a professional reviews webpage listing reviews extracted from product professionals and links to the original review written by the professional.

21) The computer program product of claim 16, wherein the digital media comprise: eBooks; paper books bought online and shipped; podcasts; digital movies, music, video games, audio books, TV shows, and desktop computer applications, that are streamed online or downloaded; and, DVD's copies purchased online and shipped to the user (e.g. DVD's).
